(19) United States
(12) Patent Application Publication
(10) Pub. No.: US 2005/0177743 A1
(43) Pub. Date: Aug. 11, 2005

(54) Method and system for a consumer upgradeable decoder

(76) Inventors: Aaron J. Barber, San Diego, CA (US); Lance M. Hobrock, Encinitas, CA (US); Keith J. Kelley, Encinitas, CA (US)

Correspondence Address: STEVEN L. NICHOLS;RADER, FISHMAN & GRAVER PLLC, 10653 S. RIVER FRONT PARKWAY, SUITE 150, SOUTH JORDAN, UT, 84095, US

(21) Appl. No.: 10/772,816

(22) Filed: Feb. 5, 2004

(51) Int. Cl. H04L 9/32

(52) U.S. Cl. 713/191

(57) ABSTRACT

A method for upgrading a consumer premise component (CPC) includes communicatively coupling a removable upgrade decoder to a CPC, the upgrade decoder being configured to decode a data stream, and downloading a computer program code to the CPC, the code enabling the CPC to access the upgrade decoder.

### FIELD

The present method and system relate to upgrading consumer components. More particularly, the present method and system provide a system and method for upgrading data format and structures used in a consumer component.

### BACKGROUND

In a typical satellite television system, subscribers are provided with a set-top box or terminal. The set-top terminal includes electronic equipment that is used to connect the subscriber's television, and potentially other electronic equipment to a satellite network. The set-top box is usually connected to the satellite network through a satellite receiver dish.

The set-top terminal is essentially a computer that is programmed to process signals received from the satellite network so as to provide the subscriber with satellite services. The set-top terminal is typically programmed to include parameters that control features of the satellite services. For example, the set-top terminal may include a parameter that allows the set-top terminal to receive and decode a specific data format. An operator of the satellite network can update the control parameters of the set-top terminal by broadcasting messages over the satellite network to the set-top terminal. Broadcasts of satellite services and messages over the satellite network are routinely performed.

However, as data transmission methods change, traditional set-top terminals become outdated and cannot be placed in conformity by a simple update of control parameters. Rather, the internal components of the set-top terminal have traditionally been updated by a physical modification of the internal components. These internal components have traditionally been modified by a technician performing a service call.

### SUMMARY

A method for upgrading a consumer premise component (CPC) includes communicatively coupling a removable upgrade decoder to a CPC, the upgrade decoder being configured to decode a data stream, and downloading a computer program code to the CPC, the code enabling the CPC to access the upgrade decoder.

### BRIEF DESCRIPTION OF THE DRAWINGS

The accompanying drawings illustrate various embodiments of the present method and system and are a part of the specification. Together with the following description, the drawings demonstrate and explain the principles of the present method and system. The illustrated embodiments are merely examples of the present system and method and in no way limit the scope there of.

FIG. 1 is a simple block diagram illustrating a satellite television network with a tree-and-branch architecture according to one exemplary embodiment.

FIG. 2 is a simple block diagram illustrating the components of a traditional integrated receiver decoder according to one exemplary embodiment.

FIG. 3 is a simple block diagram illustrating the components of an upgradeable consumer premise component (CPC) including an upgrade module according to one exemplary embodiment.

FIG. 4 is a flow chart illustrating a method for upgrading the data format and structure used in an upgradeable CPC according to one exemplary embodiment.

FIG. 5 is a flow chart illustrating a boot program operation incorporating upgrade parameters according to one exemplary embodiment.

FIG. 6 is a flow chart illustrating a method of operating a consumer upgradeable CPC according to one exemplary embodiment.

FIG. 7 is a simple block diagram illustrating traditional data flows in a consume upgradeable CPC according to one exemplary embodiment.

FIG. 8 is a simple block diagram illustrating data flow in consumer upgradeable CPC including an expansion card according to one exemplary embodiment.

Throughout the drawings, identical reference numbers designate similar, but not necessarily identical, elements.

### DETAILED DESCRIPTION

The present specification describes a number of exemplary methods and systems for upgrading a data format and/or data structure used in a consumer premise component. More specifically, the present system and method provide hardware, firmware, and system components that allow the data format and/or data structure decoded by a consumer premise component such as an integrated receiver decoder to be upgraded. The above-mentioned hardware, firmware, and system components are described in detail below.

In the present specification and in the appended claims, a data packet is meant to be understood broadly as any discrete segment of data. Data signals are typically “packetized,” meaning that the data of a message, software, or firmware is divided into discrete “packets” or segments of data. Each packet includes a header that identifies the message or object of which that packet is a part and identifies the position of that packet's data within that message or object. Consequently, a receiver of the message can collect the packets of the message or object and reassemble the packetized data into the message or object that was originally transmitted.

A “consumer premise component” or “CPC” is meant to be understood broadly as any electrical component such as a set-top box or a receiver unit that is configured to be located at a consumer location, receive a signal from a signal transmission source such as a satellite head-end unit, and process data associated with the received signal. One example of a CPC is an “integrated receiver decoder” or “IRD.” An IRD is any signal receiving device, such as a set-top box, that also decodes the received signal into decoded media signals. Once decoded, the IRD may subsequently transmit a signal to one or more display devices. A “set-top box” is meant to be understood broadly as any device, circuitry, or sub-assembly that enables a display device such as a television to receive and display programming or network services. Additionally, the term CPC may refer to any audio/video signal processing component including, but in no way limited to, a digital video recorder (DVR) or a digital video disk (DVD) player.

“Moving Picture Experts Group” or “MPEG” is meant to refer to an international standards organization body that develops data compression algorithms. The MPEG data compression algorithms take advantage of the redundancy on a frame-to-frame basis of a motion video sequence. Similarly, the term “MPEG-4” refers to a standard defining acceptable compression formats that may be used to produce real time audio and video. MPEG-4 uses an object-based approach where scenes are modeled as compositions of objects, both natural and synthetic, with which the user may interact. Visual objects in a scene are described mathematically and given a position in a two- or three-dimensional space. Similarly, audio objects are placed in a sound space. Thus, the video or audio object need only be defined once; the viewer can change his/her viewing position, and the calculations to update the audio and video are done locally.

Additionally, the term “M4M interface” or “MPEG-4 Module interface” is meant to be understood broadly as any module having an external interface that facilitates the detecting, applying power to, and communication with a coupled upgrade module. According to one exemplary embodiment illustrated herein, the M4M interface may be a field programmable gate array configured to be communicatively coupled to and control a Personal Computer Memory Card International Association (PCMCIA) type II card including an MPEG-4 decoder.

Also, the term “hot-plug” or “hot-swap” is meant to be understood broadly as any process of removing or putting a device into a system without halting the entire system. According to one exemplary embodiment, this is meant to include adding or removing a device from a bus while transactions involving other devices are occurring over the bus.

In the following description, for purposes of explanation, numerous specific details are set forth in order to provide a thorough understanding of the present method and system for upgrading the data format and structures used in a CPC. It will be apparent, however, to one skilled in the art that the present method may be practiced without these specific details. Reference in the specification to “one embodiment,” “an embodiment,” or “an exemplary embodiment” means that a particular feature, structure, or characteristic described in connection with the embodiment is included in at least one embodiment. The phrases “in one embodiment” and “in an exemplary embodiment” appear in various places in the specification and are not necessarily all referring to the same embodiment.

Exemplary Overall Structure

Referring now to the drawings, FIG. 1 illustrates a satellite television network (100) with a tree-and-branch architecture according to one exemplary embodiment. As shown in FIG. 1, the satellite television network (100) includes a satellite headend unit (110). As shown in FIG. 1, a number of data sources (102, 104, 106) may be communicatively coupled to the satellite headend unit (110) including, but in no way limited to, a plurality of servers (102), the Internet (104), radio signals, or television signals received via a satellite connection (106). The satellite headend (110) is also communicatively coupled to one or more consumer premise components (130) through a satellite broadcast network (120). The consumer premise component (130) may then be coupled to a display device (140).

As shown in FIG. 1, the satellite headend (110) is coupled to a number of data sources (102, 104, 106). The satellite headend (110) illustrated in the exemplary embodiment shown in FIG. 1 may be any centralized facility or a system at a satellite TV office that originates and communicates satellite TV services and/or satellite modem services to subscribers. The satellite TV services and/or satellite modem services may be received by the satellite headend (110) from any number of sources including those listed above. Once received in the satellite headend (110), the TV services and/or satellite modem services are encoded to eliminate redundant or irrelevant data, and information is extrapolated to reduce the overall size of the files providing the services. The TV services and/or satellite modem services are also encrypted prior to transmission to prevent unauthorized access to the signals.

The satellite broadcast network (120) illustrated in FIG. 1 is the medium over which the RF signals produced by the satellite headend unit (110) or by a CPC (130) are transmitted. The satellite broadcast network (120) may be any medium configured to transmit RF signals including, but in no way limited to, a satellite to dish network, a coaxial cable network, a fiber optic cable network, or a hybrid cable network.

Once transmitted through the satellite broadcast network (120), a downstream signal is received by a designated consumer premise component (CPC) (130). FIG. 2 illustrates the internal components of a traditional CPC (130) according to one exemplary embodiment. As shown in FIG. 2, a traditional CPC in the form of an integrated receiver decoder (IRD) (200) includes a tuner and demodulator (210) communicatively coupled to a transport processor (220). The transport processor (220) is in turn communicatively coupled to a media access control unit (conditional access device) (230) and an audio, video, data, and graphics processor (240). The audio, video, data, and graphics processor (240) is then coupled to a number of filters and buffers (250) which lead to a signal out connection (260) that may then be communicatively coupled to an external display device (140; FIG. 1).

The tuner and demodulator (210) illustrated in FIG. 2 is communicatively coupled to the transport processor (220). The tuner and demodulator (210) illustrated in FIG. 2 perform a number of functions within the CPC (200). According to one exemplary embodiment, the tuner and demodulator (210) is configured to first receive a transmitted RF signal and pass the downstream signal to the tuner portion of the tuner and demodulator (210). From there, the downstream signal is passed onto the demodulator portion. The tuner portion of the tuner and demodulator (210) receives the downstream signal tuned to a specified frequency and passes that signal onto the demodulator portion. The demodulator portion of the tuner and demodulator (210) is configured to take a received RF signal and recover from it a transmitted digital signal such as an encrypted MPEG stream. According to one exemplary embodiment, the demodulator portion of the tuner and demodulator (210) is an 8-phase shift keying modulation (8PSK) demodulator.

Once recovered from the tuner and demodulator (210), the transmitted digital signal is further transmitted to the transport processor (220) where it may be decrypted and further routed. The transport processor (220) may also optionally transmit a selected portion of the transmitted digital signal to the media access control unit (230) for authorization.

A media access control unit (230) is communicatively coupled to the transport processor (220) according to one exemplary embodiment illustrated in FIG. 2. The transport processor (220) acts as the interface between the hardware and software portions of the various network protocols. When an encrypted MPEG stream is received in the transport processor, the media access control unit (230) may be accessed to determine if the IRD (200) has been granted permission to access the received signal and/or to decrypt or otherwise manipulate the encrypted data streams.

Also coupled to the transport processor (220) of the IRD (200) is an audio, video, data, and graphics processor (240). The audio, video, data, and graphics processor (240) that is communicatively coupled to the transport processor (220) as illustrated in FIG. 2 may include a high definition video decoder. Upon reception of permission to further process a received signal, the transport processor (220) may transmit the signal to the audio, video, data, and graphics processor (240) to be decoded and prepared for further processing through the filters and buffers (250). According to one exemplary embodiment, the audio, video, data, and graphics processor includes, but is in no way limited to a BCM7035 advanced high-definition signal decoder.

A number of filters and buffers (250) are communicatively coupled to the audio, video, data, and graphics processor (240) as illustrated in FIG. 2. The filters and buffers (250) illustrated in FIG. 2 are configured to receive the reconstructed analog and/or digital waveforms produced by the audio, video, data, and graphics processor and clean up the reconstruction artifacts. According to one exemplary embodiment, a low-pass filter is included in the filters and buffers (250) to remove images created by a digital-to-analog converter's sampling rate. Once processed by the filters and buffers (250), the video and audio signals received from the audio, video, data, and graphics processor are in condition to be transmitted to a signal output (260) and on to a display device (140; FIG. 1).

While the traditional CPC (130) illustrated in FIG. 2 is capable of receiving and decoding current data compression formats such as MPEG 2, it is only a matter of time before more efficient data compression algorithms and methods such as MPEG 4 and/or WM9 are widely adopted by the media industry. Traditionally, when a new data compression method or algorithm was widely adopted and used in the transmission of both audio and video data to consumer premise components, the older CPCs (130) configured to decode the antiquated data compression methods became useless when provided signals encoded by the upgraded data compression methods and/or algorithms. In order to upgrade these traditional CPCs, manufacturers or media transmission companies would traditionally be required to send a system repairman to the location of the traditional CPC to perform a customer service call, thereby upgrading the CPC. These customer service calls and upgrades are both expensive for the manufacturers and media transmission companies as well as temporally inefficient.

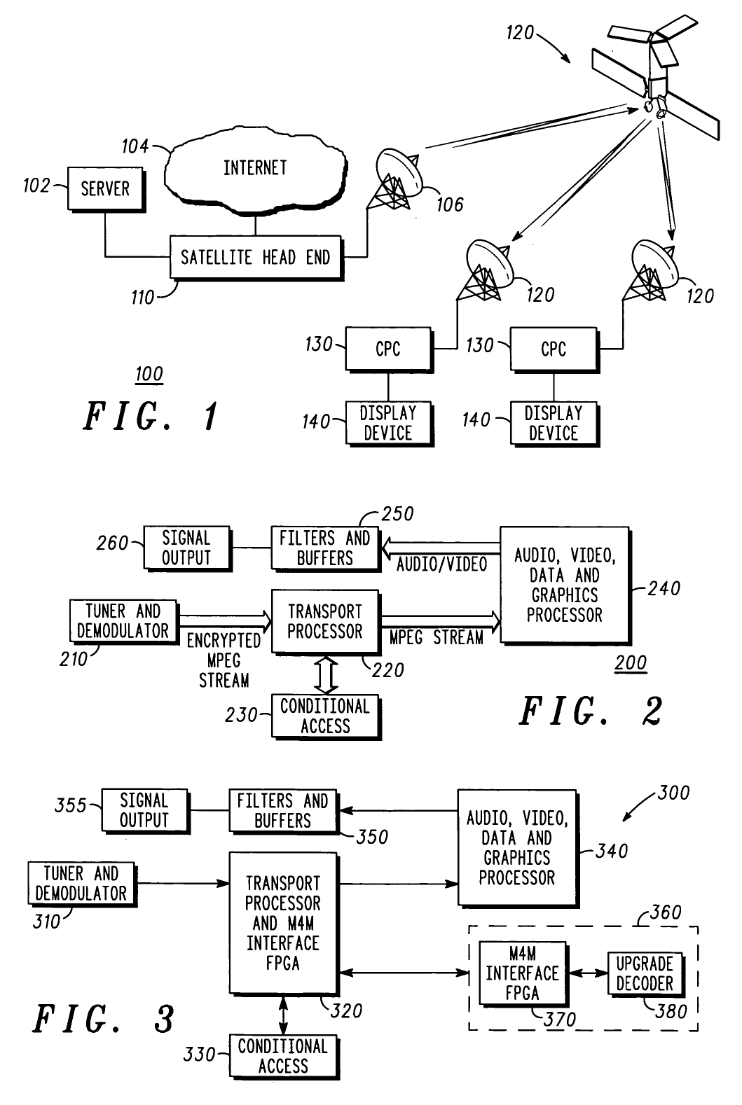

FIG. 3 illustrates the components of a consumer upgradeable CPC (300) that will eliminate the need for the above-mentioned service calls according to one exemplary embodiment. As illustrated in FIG. 3, the consumer upgradeable CPC (300) includes many of the same components as the traditional CPC. More specifically, the exemplary consumer upgradeable CPC illustrated in FIG. 3 includes a tuner and demodulator (310) communicatively coupled to a first transport processor & M4M interface FPGA (320). According to one exemplary embodiment, the first transport processor & M4M interface FPGA (320) is configured to detect and apply power to a communicatively coupled upgrade module (360). The transport processor & M4M interface FPGA (320) will also encrypt and decrypt any audio or video information transmitted between the upgradeable CPC (300) and an upgrade module (360). This encryption is based on private key exchange carried out after the upgradeable CPC (300) and the upgrade module (360) are personalized and mated to each other. Additionally, according to one exemplary embodiment, the first transport processor & M4M interface FPGA (320) includes hot-plug buffers allowing an upgrade module (360) to be hot swappable with the present upgradeable CPC (300). Moreover, according to one exemplary embodiment, the first transport processor & M4M interface FPGA (320) includes a 68-pin male PCMCIA connector.

The first transport processor & M4M interface FPGA (320) is then communicatively coupled to a conditional access control unit (330) and a signal decoder (340). The signal decoder (340) is then communicatively coupled to a plurality of filters and buffers (350) before being routed to a signal out port (355). The components of the consumer upgradeable CPC (300) illustrated in FIG. 3 that are similar to those illustrated in FIG. 2 perform similar functions as explained above.

However, in contrast to the traditional CPC illustrated in FIG. 2, the consumer upgradeable CPC (300) includes an upgrade module (360) communicatively and removeably coupled to the first transport processor & M4M interface FPGA (320). The upgrade module (360) illustrated in FIG. 3 includes a second M4M interface FPGA (370) communicatively coupled to an upgrade decoder (380). According to one exemplary embodiment, the upgrade module (360) is hot swappable with the upgradeable CPC (300) and includes a 68-pin female PCMCIA connector.

The second M4M interface FPGA (370) included in the upgrade module (360) enables quick connection to, and communication between the first transport processor & M4M interface FPGA (320) and the upgrade decoder (360). According to one exemplary embodiment, the second M4M interface FPGA (370) is programmed by the programmable CPC upon insertion and coupling with the first transport processor & M4M interface FPGA (320). Once the second M4M interface FPGA (370) is programmed, it will in turn program the upgrade decoder (360) and begin decoding received signals.

The upgrade decoder (360) illustrated in FIG. 3 may be any program, circuit, or algorithm which decodes data from a compressed data format and converts it to an uncompressed digital video and audio format. According to one exemplary embodiment, the upgrade decoder (380) illustrated in FIG. 3 is an MPEG-4 decoder configured to decode a received MPEG-4 video and audio stream. In an alternative embodiment, the upgrade decoder (380) illustrated in FIG. 3 is a Windows Media 9 (WM9) decoder.

Exemplary Implementation and Operation

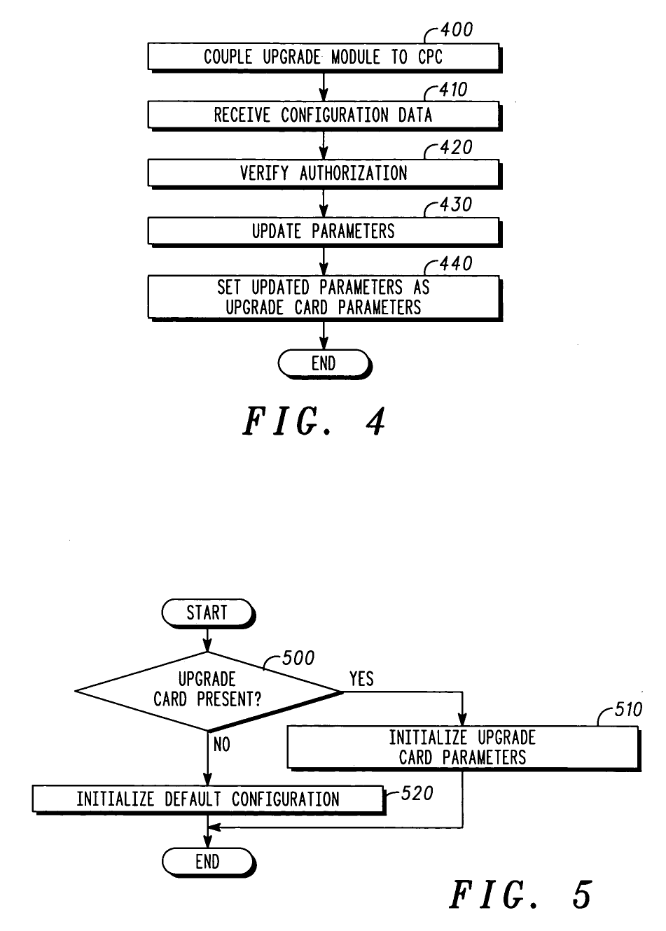

FIG. 4 illustrates an exemplary method for upgrading the data format and/or structures used in a CPC according to one exemplary embodiment. As illustrated in FIG. 4, the present method begins by coupling the upgrade module (360; FIG. 3) to a CPC (step 400). According to one exemplary embodiment, the upgrade module (360; FIG. 3) is communicatively coupled to the first Transport Processor & M4M interface FPGA (320; FIG. 3) of the CPC (300; FIG. 3) through a plug-in connection. According to this exemplary embodiment, the upgrade module is inserted to a slot (not shown) on the outside of the CPC casing. When inserted into the slot, the upgrade module (360; FIG. 3) is guided until it electrically mates with a connector (not shown) electrically coupled to the first Transport Processor & M4M interface FPGA (320; FIG. 2). When the upgrade module (360; FIG. 3) is electrically mated with the connector as explained above, it may be detected by the first Transport Processor & M4M interface FPGA (220; FIG. 3) and the following process may be enabled. It will be noted, however, that any number of connectors and/or cables may be used to communicatively couple the upgrade module to the CPC.

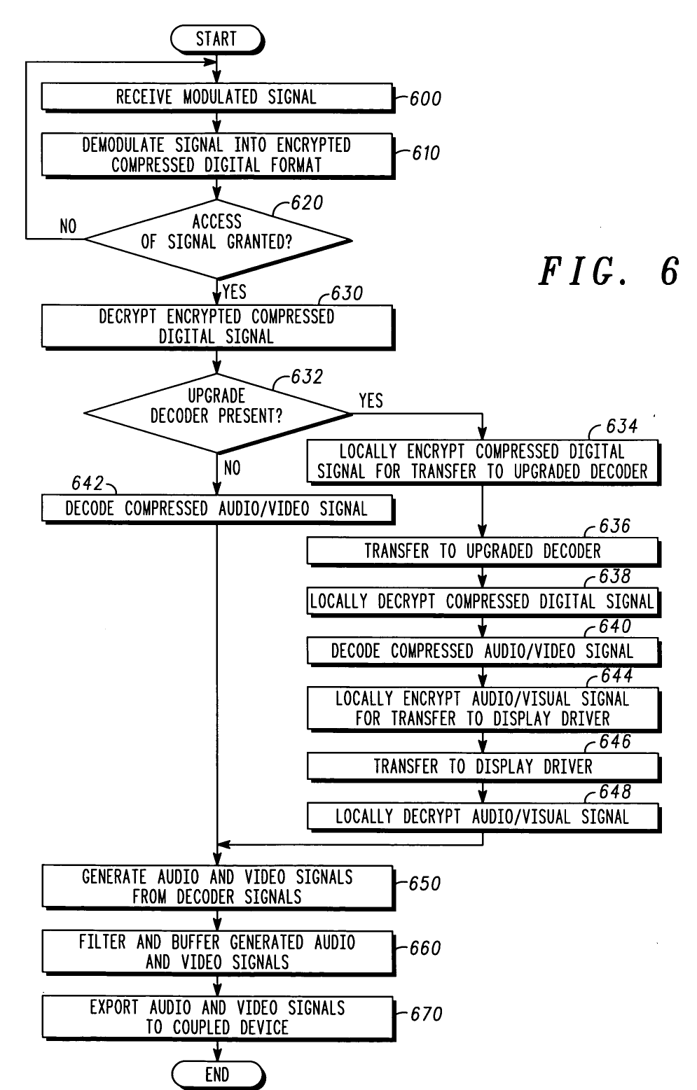

Once the upgrade module (360; FIG. 3) is communicatively coupled to the CPC (300; FIG. 3), the CPC may then receive configuration data (step 410). According to one exemplary embodiment, configuration data is transmitted to the CPC (300; FIG. 3) from the satellite head end (110; FIG. 1). According to this exemplary embodiment, the satellite head end (110; FIG. 1) may either transmit configuration data globally to all CPC terminals coupled to the satellite network (100) by a global download parameters transaction, or the configuration data may be selectively transmitted to identified CPCs (300; FIG. 3) through an addressable transaction. According to this exemplary embodiment, the received configuration data will be used to enable the use of the upgrade module (360; FIG. 3) by the CPC (300; FIG. 3) as will be further explained below with reference to FIGS. 6 through 8.

Once the configuration data is received by the CPC (300; FIG. 3), the CPC may optionally verify authorization (step 420) to use the configuration data and then use the received configuration data to update the CPC operation parameters (step 430). According to one exemplary embodiment, the CPC may automatically verify authorization to use the configuration data by accessing an identification number associated with the upgrade module (360; FIG. 3). Alternatively, the user may be asked to input an authorization code though any number of user interfaces.

The configuration data may then be used to update the CPC operation parameters (step 430). According to this exemplary embodiment, the CPC operation parameters may be updated to allow proper communication and interaction between the first Transport Processor & M4M interface FPGA (320; FIG. 3) of the CPC (300; FIG. 3) and the upgrade module (360; FIG. 3) as will be illustrated below with reference to FIGS. 6 through 8.

The updated parameters may also be set as “upgrade card configuration parameters” to be further accessed during standard boot program operations (step 440). FIG. 5 illustrates one exemplary method for incorporating “upgrade card configuration parameters” during a standard boot program operation. As illustrated in FIG. 5, when the boot program starts due to a power up or other similar operation, the CPC (300; FIG. 3) determines whether or not an upgrade card (360; FIG. 3) has been coupled to the CPC (step 500). Detection of a communicatively coupled upgrade card may be performed by any number of methods currently incorporated by standard boot programs. If no upgrade card (360; FIG. 3) is detected as being communicatively coupled to the CPC (NO, step 500), the default configuration parameters which direct traditional operation of the CPC may be initialized (step 520). If, however, an upgrade card (360; FIG. 3) is detected as being communicatively coupled to the CPC (YES, step 500), the above mentioned “upgrade card configuration parameters” are initialized (step 510). Additionally, when an upgrade card (360; FIG. 3) is detected, it is supplied power and programmed by the first Transport Processor & M4M interface FPGA (320; FIG. 3).

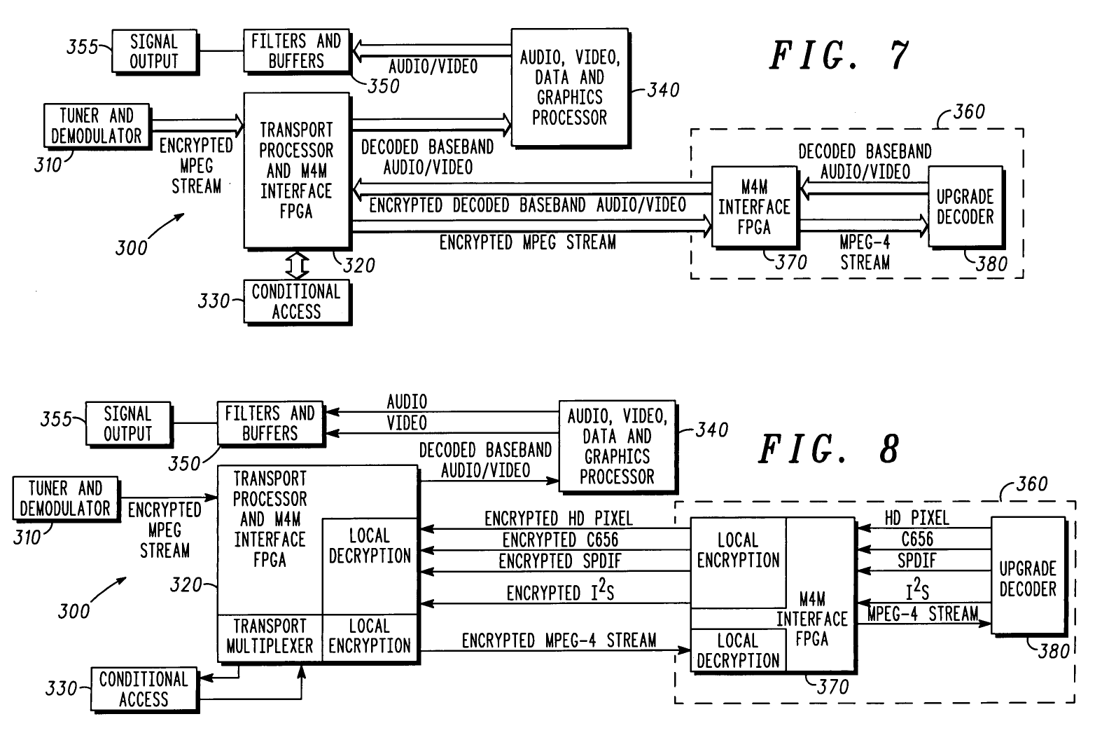

FIG. 6 illustrates a method of operating a consumer upgradeable CPC (200; FIG. 3) after receiving an upgrade module (360; FIG. 3) according to one exemplary embodiment. As illustrated in FIG. 6, the method of operation begins when the CPC receives a modulated signal (step 600). After the signal is received by the CPC, the modulated signal is demodulated into an encrypted and compressed digital format (step 610). After the received signal is demodulated, the first transport processor & M4M interface FPGA (320; FIG. 3) of the CPC determines if access to the received signal is granted (step 620). If access to the received signal has not been granted (NO, step 620), no further process is performed, and the CPC receives another modulated signal (step 600). If, however, access to the received signal has been granted (YES, step 620), the encrypted and compressed digital signal is decrypted by the first transport processor & M4M interface FPGA (step 630) and the CPC determines if the upgrade decoder is present (step 632). If the upgrade decoder is not present (NO, step 632) then the signal is decoded (step 642) into a number of audio, visual, and clock signals using the local audio, video, data and graphics processor (340; FIG. 3), if possible. If the upgrade decoder is present (YES, step 632) the compressed signal is locally encrypted for transmission to the upgrade decoder (step 634). The compressed signal is then transferred across the interface (step 636) and then locally decrypted in the upgrade module (360; FIG. 3) for use in the upgrade decoder (step 638). The signal is decoded (step 640) into a number of audio, visual, and clock signals using the upgrade decoder (380; FIG. 3) then locally encrypted (step 644) by the second M4M interface FPGA (370; FIG. 3) for transmission to the first transport processor & M4M interface FPGA (320; FIG. 3) on the CPC (300; FIG. 3). The encrypted decoded audio\video signal is then transferred across the interface to the CPC (step 646) and locally decrypted (step 648). The decoded signals are then used by the local audio, video, data and graphics processor (340; FIG. 3) to generate audio and video signals (step 650), which may then be filtered and buffered (step 660) and exported to a communicatively coupled device (step 670). The above-mentioned method of operation will now be described in further detail below with reference to FIGS. 7 and 8.

As illustrated in FIG. 6, the method of operation begins by receiving a modulated signal in the CPC (step 600). Turning now to FIG. 7, the received signal is received by the tuner and demodulator (310). The received signal may be modulated according to any number of modulation methods that correspond with signal transmission. Once received, the demodulator (210) performs a demodulation function resulting in an encrypted and compressed data stream (step 610; FIG. 6). According to one exemplary embodiment illustrated in FIG. 7, the encrypted and compressed data stream may be an encrypted MPEG-4 data stream. While the present system and method will be described below, for ease of explanation only, in terms of a received MPEG-4 data stream, the present system and method may be applied to the upgrade of a CPC to decode any number of data compression data streams including, but in no way limited to, an MPEG-4 data stream or a WM9 data stream.

Once the received modulated signal is demodulated into an encrypted and compressed digital format (step 610; FIG. 6), the CPC may optionally determine whether access to the received signal has been granted (step 620; FIG. 6). As illustrated above, access to the received signal may be granted by a signal transmitted from the satellite head end component (110; FIG. 1), or by a code entered into the CPC through a user interface. Regardless of the method used, conditional access may be confirmed by communication between the first transport processor & M4M interface FPGA (320) and the conditional access unit (330) as indicated by the arrow in FIG. 7. If access to the received signal has not been granted (NO, step 620; FIG. 6), no further process is performed, and the CPC (300) receives and begins to process another modulated signal (step 600; FIG. 6).

If, however, access to the received signal has been granted (YES, step 620; FIG. 6), the encrypted and compressed MPEG-4 signal is decrypted using a network conditional access algorithm and is then transmitted to the first transport processor & M4M interface FPGA (320).

Once the data signal is decrypted, the CPC (300) determines whether the upgrade decoder (380) is communicatively coupled to the CPC (step 632; FIG. 6). If the upgrade decoder (380) is not communicatively coupled to the CPC (NO step 632; FIG. 6), the CPC (300) will attempt to decode the decrypted signal into a number of audio, visual, and clock signals using the local audio, video, data and graphics processor (step 642; FIG. 6), if possible.

If, however, the upgrade decoder (380) is communicatively coupled to the CPC (YES, step 632; FIG. 6), the first transport processor & M4M interface FPGA (220) locally encrypts the compressed signal (step 634; FIG. 6) and this signal is transferred (step 636; FIG. 6) across the interface to the second M4M interface FPGA (370) that forms part of the upgrade module (360). The second M4M interface FPGA then locally decrypts the local encryption on the MPEG-4 data stream (step 638; FIG. 6) and transmits the decrypted MPEG-4 data stream to the upgrade decoder (380). According to one exemplary embodiment, the local encryption/decryption used when transmitting a data stream over the M4M interface is based on a private key exchange initialized when the programmable CPC (300) and the upgrade decoder (380) are personalized and mated to each other. According to the exemplary embodiment illustrated in FIG. 7, the upgrade decoder (380) is an MPEG-4 decoder. However, due to the extractability of the upgrade module (360), the present system and method may be used to upgrade a CPC (200) to decode any number of data compression methods by simply utilizing an upgrade module (360) incorporating a corresponding decoder.

Upon receiving the MPEG-4 data stream, the MPEG-4 decoder (380) decodes the compressed audio/visual data stream (step 640; FIG. 6) into a decoded baseband audio/video signal as illustrated in FIG. 7. FIG. 8 further illustrates the components of the decoded baseband audio/video signal according to one exemplary embodiment. As illustrated in FIG. 8, the MPEG-4 decoder (380) decodes the MPEG-4 data stream into a number of distinct signals including, but in no way limited to, a Sony Philips Digital Interface Format (SPDIF) signal, a high-definition (HD) Pixel signal, a Consultative Committee for International Radio (CCIR) 656 signal, and an Inter Integrated Circuit Sound (I²S) signal. According to the exemplary embodiment illustrated in FIG. 8, the HD pixel signal represents a video content signal. Similarly, the I²S signal handles an audio content signal separately from clock signals, thereby eliminating the need for anti jitter devices. The CCIR656 signal is a standard for digital component electrical interfaces that defines synchronizing signals and blanking, as well as parallel and serial interface specifications. The SPDIF signal is a standard audio transfer file format that allows the transfer of audio without the conversion to and from an analog format, which could degrade the signal quality.

As illustrated in FIG. 8, the above-mentioned decoded baseband audio/video signals are then transmitted within the upgrade module from the MPEG-4 decoder (380) to the second M4M interface FPGA (370) according to one exemplary embodiment. The second M4M interface FPGA (370) then locally encrypts the decoded baseband audio/video signals (step 644; FIG. 6) using a local encryption/decryption engine and transmits the encrypted decoded baseband audio/video signals to the first transport processor & M4M interface FPGA (320) over the interface (step 646; FIG. 6). Once decrypted (step 648; FIG. 6) by the first transport processor & M4M interface FPGA (320), the media signals are in a form that may be further processed using the traditional components of the CPC (300). According to the exemplary embodiment illustrate in FIG. 8, the HD pixel, CCIR656, SPDIF, and I²S signals are transmitted to the audio, video, data, and graphics processor (340) where they are used to generate both audio and video signals (step 650; FIG. 6) according to the previously antiquated signal processing methods. Once the audio signal and the video signal are generated by the CPC audio, video, data, and graphics processor (340), they are refined by being passed through the filters and buffers (step 660; FIG. 6) on their way to being exported to a communicatively coupled device (step 670; FIG. 6).

While the above-mentioned method was described in the context of receiving and processing a media content signal transmitted over a satellite network, the present system and method may be incorporated by any number of media signal processing networks including, but in no way limited to, other wireless transmission networks, hybrid cable networks, fiber optic networks, and the like. Accordingly, the present system and method may be used to allow any number of consumer components to be upgraded to process innovative media compression methods or other data format and processing methods using traditional or otherwise antiquated components.

In conclusion, the present method and system for upgrading the data format and structures used in a CPC or other signal receiving and processing device reduces upgrade costs to both consumers and service providers. More specifically, the present method and system allows a consumer to receive and process media signals compressed or otherwise processed by innovative methods using traditional components. By communicatively coupling and otherwise incorporating an innovative processor configured to process the innovative signals to the traditional components, cost to the consumer is reduced. Similarly, service providers may enable the incorporation of the innovative processor without costly service calls. Rather, the above-mentioned systems and methods may be enabled remotely from the satellite headend unit, after insertion of the upgrade module.

The preceding description has been presented only to illustrate and describe the present method and system. It is not intended to be exhaustive or to limit the present method and system to any precise form disclosed. Many modifications and variations are possible in light of the above teachings.

The foregoing embodiments were chosen and described in order to illustrate principles of the method and system as well as some practical applications. The preceding description enables others skilled in the art to utilize the method and system in various embodiments and with various modifications as are suited to the particular use contemplated. It is intended that the scope of the method and system be defined by the following claims.

1. A method comprising:
communicatively coupling a removable upgrade decoder to a consumer premise component (CPC), said upgrade decoder being configured to decode a data stream; and
downloading a computer program code to said CPC, said code enabling said CPC to access said upgrade decoder.

2. The method of claim 1, wherein said data stream comprises one of a Moving Picture Experts Group-4 (MPEG-4) data stream or a Windows Media 9 (WM9) data stream.

3. The method of claim 1, wherein said downloading a computer program code to said CPC further comprises:
providing a boot code program configured to detect said upgrade decoder; and
if said upgrade decoder is detected, initializing said boot code program.

4. The method of claim 1, wherein said program is configured to cause said CPC to:
receive said data stream;
transmit said data stream to said upgrade decoder to be decoded; and
receive a decoded data stream from said updated decoder.

5. The method of claim 1, wherein said removable upgrade decoder further comprises:
an interface field programmable gate array (FPGA) configured to interface with said CPC; and
a signal decoder, wherein said signal decoder is configured to increase a signal decoding capability of said CPC.

6. The method of claim 5, wherein said signal decoder comprises one of an MPEG 4 decoder or a WM9 decoder.

7. The method of claim 1, further comprising:
receiving a compressed audio/video data stream;
transmitting said compressed audio/video data stream to said signal decoder; and
decoding said compressed audio/video data stream with said signal decoder.

8. The method of claim 7, wherein said transmitting said compressed audio/video data stream to said signal decoder comprises:
locally encrypting said compressed audio/video data stream in said CPC;
transmitting said encrypted compressed audio/video data stream to said removable upgrade decoder; and
locally decrypting said encrypted compressed audio/video data stream in said removable upgrade decoder.

9. A consumer premise component (CPC), comprising:
a tuner;
a demodulator;
a first interface field programmable gate array (FPGA) communicatively coupled to said demodulator; and
a first signal decoder communicatively coupled to said interface field programmable gate array;
wherein said first interface FPGA is configured to be communicatively coupled to a removable upgrade decoder, said removable upgrade decoder including a second interface FPGA communicatively coupled to a second signal decoder.

10. The CPC of claim 9, wherein said CPC comprises one of a set-top box, a receiver unit, a digital video recorder (DVR), a digital video disk (DVD) player, or an integrated receiver decoder.

11. The CPC of claim 9, wherein said first interface FPGA is further configured to download a computer program code configured to enable said CPC to access said upgrade decoder.

12. The CPC of claim 11, wherein said first interface FPGA is further configured to:
provide a boot code program configured to detect said upgrade decoder; and
if said upgrade decoder is detected, initialize said boot code program.

13. The CPC of claim 9, wherein said first interface FPGA is further configured to:
locally encrypt audio/video signals prior to transmission; and
locally decrypt received encrypted audio/video signals.

14. The CPC of claim 9, wherein said first interface FPGA further comprises a hot-plug buffer configured to allow said removable upgrade decoder to be hot-swapped with said CPC.

15. The CPC of claim 9, wherein said upgrade decoder is configured to decode one of a Moving Picture Experts Group-4 (MPEG-4) data stream or a Windows Media 9 (WM9) data stream.

16. The CPC of claim 9, further comprising a plurality of buffers and filters communicatively coupled to said first signal decoder.

17. The CPC of claim 9, wherein said upgrade decoder is configured to receive a coded data stream and decode said coded data stream into a data format compatible with said first signal decoder.

18. An upgrade decoder comprising:
an interface field programmable gate array (FPGA) configured to interface with a consumer premise component (CPC); and
a signal decoder, wherein said signal decoder is configured to increase a signal decoding capability of said CPC.

19. The upgrade decoder of claim 18, wherein said upgrade decoder is configured to be removably coupled to said CPC.

20. The upgrade decoder of claim 18, wherein said signal decoder comprises one of a Moving Picture Experts Group-4 (MPEG-4) data stream decoder or a Windows Media 9 (WM9) data stream decoder.

21. The upgrade decoder of claim 18, wherein said FPGA further comprises:
an encryption/decryption engine configured to locally encrypt and decrypt audio/video signals; and
a hot-plug buffer configured to allow said upgrade decoder to be hot-swapped with said CPC.

22. A processor readable medium having instructions thereon for:
detecting the presence of an upgrade decoder communicatively coupled to a consumer premise component (CPC);
downloading a program code enabling said CPC to access said upgrade decoder; and
if said upgrade decoder is detected, running said downloaded program code.

23. The processor readable medium of claim 22, wherein said downloading a program code further comprises:
downloading a boot code program configured to detect said upgrade decoder; and
if said upgrade decoder is detected, initializing said boot code program.

24. The processor readable medium of claim 22, further having instructions thereon for:
passing a received media signal to said upgrade decoder for decoding;
receiving a decoded media signal from said upgrade decoder; and
further processing said decoded media signal through traditional circuitry in said CPC.

25. The processor readable medium of claim 24, wherein said instructions for passing a received media signal to said upgrade decoder for decoding further comprises instructions for locally encrypting said received media signal prior to passing said received media signal to said upgrade decoder.
